(19) United States
(12) Patent Application Publication
(10) Pub. No.: US 2009/0094685 A1
(43) Pub. Date: Apr. 9, 2009

(54) METHOD AND ARRANGEMENT FOR ACCESSING CALL NUMBER PORTABILITY DATA

(75) Inventors: Andreas BERG, Berlin (DE); Uwe KLATT, Oslo (NO); Thomas RYLL, Berlin (DE)

Correspondence Address: BELL, BOYD & LLOYD, LLP, P.O. BOX 1135, CHICAGO, IL, 60690, US

(73) Assignee: Nokia Siemens Networks GMBH & Co., Meunchen (DE)

(21) Appl. No.: 12/335,155

(22) Filed: Dec. 15, 2008

Related U.S. Application Data
(63) Continuation of application No. 10/455,811, filed on Jun. 6, 2003, now abandoned.

(30) Foreign Application Priority Data
Jun. 7, 2002 (DE) 102 26 344.2

(51) Int. Cl. G06F 7/04

(52) U.S. Cl. 726/4

(57) ABSTRACT

The invention relates to a method for accessing MNP data, which is stored in an MNP memory in a mobile radio network, by a network-external data processing device. The network interface, which in terms of signal flow is arranged between the network-external data processing device and the MNP memory, checks whether the network-external data processing device is authorized to access the MNP data. If the authorization is present, an identification for a communication terminal is transmitted by the network interface from the network-external data processing device to the MNP memory, MNP data which is associated with the communication terminal is read from the MNP memory, and this MNP data is transmitted via the network interface to the network-external data processing device.

### CLAIM FOR PRIORITY

This application claims priority to German Application No. 10226344.2 which was filed on Jun. 7, 2002.

### TECHNICAL FIELD OF THE INVENTION

The present invention relates to a method and arrangement for accessing call number portability data, and in particular, data which is stored in a Mobile Number Portability (MNP) memory in a mobile radio network.

### BACKGROUND OF THE INVENTION

In the course of liberalizing telecommunications markets, numerous countries throughout the world are developing methods to allow mobile radio subscribers to retain their mobile radio call number (MSISDN=mobile Station ISDN Number) when changing from one mobile radio network operator to a different mobile radio network operator (for example in the same country). These methods are known by the term “Mobile Number Portability” (MNP). MNP databank systems (MNP memories) are likewise generally known in mobile radio networks, and make it possible for the respective mobile radio network operators to store or to call up associations between mobile radio call numbers and mobile radio networks in the respective country, in a national context. MNP memories such as these are accessed within the mobile radio network of the respective mobile radio network operator.

### SUMMARY OF THE INVENTION

The invention discloses a method and an arrangement which widens the usage capabilities for call number portability data being stored in MNP memories.

According to one embodiment of the invention, there is a method for accessing MNP data, which is stored in an MNP memory in a mobile radio network, by a network-external data processing device, in which a network interface, which in terms of signal flow is arranged between the network-external data processing device and the MNP memory, checks whether the network-external data processing device is authorized to access the MNP data, if the authorization is present, an identification for a communication terminal is transmitted by the network interface from the network-external data processing device to the MNP memory, MNP data which is associated with the communication terminal is read from the MNP memory, and the MNP data is transmitted via the network interface to the network-external data processing device. In this case, it is particularly advantageous for a network-external data processing device, that is a device which is not located in the mobile radio network (with which the MNP memory is associated) to be able to access the MNP data in the MNP memory using the network interface. It is also advantageous, before allowing access, for the network interface to check whether the external data processing device is authorized to access the MNP data, or to use the MNP data.

In another embodiment of the invention, an authentication and authorization of the data processing device are carried out by the network interface in order to check the authorization of the data processing device. This advantageously on the one hand confirms the identity of the external data processing device, and on the other hand confirms the access authorization to MNP data.

In another embodiment of the invention, the authentication and authorization are carried out by a network interface, which is in the form of an OSA intermediate node, in accordance with “Open Service Access” (OSA) requirements. The use of an OSA intermediate node (OSA gateway) as a network interface is particularly advantageous since the OSA technology makes use of a technology that is known per se, but has until now been used for other purposes, to allow accesses by network-external MNP data users to MNP memories. The invention can thus be implemented with little complexity and thus particularly cost-effectively.

According to one preferred embodiment, the MNP data is transmitted via a network interface which has an access unit in the form of an OSA-conformal application programming interface (API). One aspect of the access unit in advantageously allows the security mechanisms and security infrastructures that are provided in the OSA Standards to be used during access to the MNP data.

In still another embodiment of the invention, an identifier for the home mobile radio network of the communication terminal is transmitted as the MNP data. This embodiment advantageously makes it possible for the network-external data processing device to determine the home mobile radio network of the communication terminal.

The invention can also be carried out such that an address of an entry switching center for the home mobile radio network of the communication terminal is transmitted as the MNP data. In this case, information is transmitted to the network-external data processing device, which makes it possible for this device to communicate with the home mobile radio network.

In another embodiment of the invention, the access data for a payment system, which is associated with the communication terminal, for the home mobile radio network of the communication terminal is transmitted as the MNP data. The transmission of the access data for the payment system advantageously makes it possible for the network-external data processing device to make contact with the payment system and to use its services for handling payments which relate to the communication terminal, or to a user of the communication terminal.

In yet another embodiment of the invention, a data processing device which operates as a payment system and is associated with some other mobile radio network transmits an access request, relating to the MNP memory, to the network interface, if an authorization for the data processing device is present, a mobile radio call number is transmitted to the MNP memory as an identification for the communication terminal, the access data for the payment system, which is associated with the communication terminal, for the home mobile radio network of the communication terminal is then read from the MNP memory as MNP data, and this access data is transmitted to the data processing device. One advantageous feature is that the access data for the payment system which is responsible for the home mobile radio network of the communication terminal is transmitted to the payment system for the other mobile radio network (which is acting as a data processing device). This makes it possible for the payment system for the other mobile radio network to initiate or implement payments which relate to that communication terminal, in collaboration with the payment system for the home mobile radio network of this communication terminal.

In another embodiment of the invention, there is an arrangement having an MNP memory for a mobile radio network, which includes MNP data in the form of association data between identifications for communication terminals and devices in the home mobile radio networks of these communication terminals, and a network interface for the mobile radio network, which allows a network-external data processing device to have access to the MNP data. This arrangement according to the invention advantageously allows the network interface for the mobile radio network to access the MNP data for a data processing data which is arranged outside the mobile radio network.

In this arrangement, the network interface may be in the form of an intermediate node which operates in accordance with “Open Service Access” requirements. The use of the OSA intermediate node makes it possible to use the OSA technology, which is known per se, to provide a network interface which allows network-external computers to have access to MNP databanks. The arrangement can thus be implemented with little complexity and cost-effectively.

The arrangement according to the invention may have a subscriber payment system for the mobile radio network, whose access data is stored as MNP data in the MNP memory. This embodiment of the arrangement according to the invention advantageously allows the network-external data processing device to have access to access data to the subscriber payment system. This allows communication between the network-external data processing device and the subscriber payment system.

### BRIEF DESCRIPTION OF THE DRAWINGS

The invention is described below in detail with reference to the drawings, in which:

FIG. 1 shows one exemplary embodiment of an arrangement according to the invention and of a method according to the invention.

FIG. 2 shows a further exemplary embodiment of the arrangement according to the invention and of the method according to the invention for carrying out payment processes in mobile radio networks.

### DETAILED DESCRIPTION OF THE INVENTION

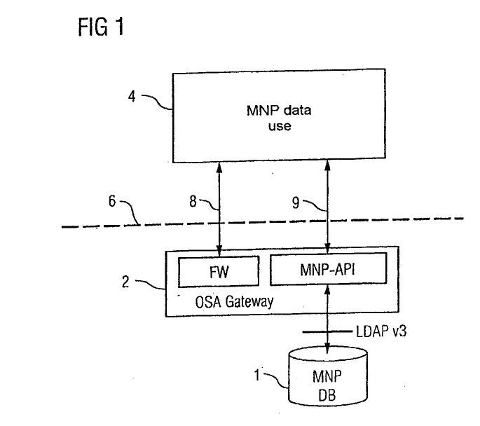

FIG. 1 shows an MNP memory 1 (MNP databank) which is associated with a mobile radio network. MNP data is stored in the MNP memory. The expression MNP data means data which includes or describes an association between an identification for a communication terminal (for example the mobile radio call number MSISDN) and its home mobile radio network, its home network operator or devices in this home mobile radio network. In this case, the home mobile radio network for a communication terminal is, for example, that network for which a contract exists between the respective mobile network operator and the respective communication terminal operator.

The MNP memory 1 is connected to a network interface 2, which is in the form of a connecting node or intermediate node which operates in accordance with the requirements of the “Open Service Access” Standard. An OSA connecting node such as this is also referred to as an OSA gateway. A unit FW (FW=OSA framework) and an access unit MNP-API are shown as major components of the network interface 2. The functions of the unit FW and of the access unit MNP-API will be explained in more detail in the following text.

The upper part of FIG. 1 shows a network-external data processing device 4. This is, for example, a data processing device which is arranged outside the mobile radio network, as is indicated by the dashed line 6.

One exemplary embodiment of a procedure for the method according to the invention will be described in the following text. It is assumed that the network-external data processing device 4 wishes to access the MNP memory 1, in order to read MNP data that is stored in this memory. To do this, the data processing device 4 sends an access request to the network interface 2 via a first information channel 8. This access request is passed to the unit FW. The unit FW prevents unauthorized access by network-external data processing devices to the MNP memory 1. To do this, the unit FW carries out functions which are known per se from the standardized Open Service Access mechanisms and are described, by way of example, in the documents “3GPP TS 29.198-3, V4.4.0, (2002-03), Technical Specification, 3rd Generation Partnership Project; Technical Specification Group Core Network; Open Service Access (OSA); Application Programming Interface (API); Part 3: Framework (Release 4)” and “3GPP TS 22.127, V5.3.0, (2003-03), Technical Specification, 3rd Generation Partnership Project; Technical Specification Group Services and System Aspects; Service aspects; Stage 1 Service Requirement for the Open Service Access (OSA) (Release 5)”. The unit FW carries out authentication functions, that is confirms the identity of the requesting data processing device. It carries out authorization functions, that is it confirms whether the network-external data processing device 4 has authorization to access the MNP memory, and grants it such authorizations. If the result of a check is positive, the unit FW allows the network-external data processing device 4 to access the MNP memory 1 (grant of access). In this way, the unit FW provides the security that is necessary for access to sensitive MNP data.

Once the unit FW has checked the authorizations, the access unit MNP-API (MNP-API Mobile Number Portability Application Programming Interface) is used according to the invention to allow the data processing device 4 to have direct access to the MNP data in the MNP memory 1. The access unit MNP-API thus represents the actual MNP data interface between the MNP databank 1 and the MNP data user 4 (and is thus a unit that is significant to the invention). The access unit MNP-API in this example is based on OSA technology and thus represents an OSA-conformal “Application Programming Interface” (API). This access unit MNP-API allows devices which are external to the mobile radio network to ask a question, which includes an identification of a communication terminal, to the MNP memory 1, and a data channel 9 is used for this purpose. By way of example, one such identification for a communication terminal is the mobile radio call number MSISDN of a mobile radio subscriber. The access unit MNP-API also allows the network-external data processing device 4 to check MNP data which is stored in the MNP memory 1 (and which is associated with the identification for the communication terminal). By way of example, as MNP data such as this, it is possible to check and to read from the MNP memory: the association between the communication terminal or its user (mobile radio subscriber) and a mobile radio home network operator, the association between the communication terminal and an address of an entry switching center (gateway MSC, GMSC) for the home network of the mobile radio subscriber, and/or an association between the communication terminal and an address of a payment system which is associated with the mobile radio subscriber. However, further data which is stored as MNP data in the MNP memory 1 may also be checked via the access unit MNP-API.

The access unit MNP-API may, for example, be based on JAVA and/or CORBA technologies, using the “JAVA Database Connectivity” technology from Sun Microsystems. Alternatively, it is also possible to use the “Interface Definition Language” from the “Object Management Group”. This solution is advantageously independent of language and implementation. The access unit MNP-API is integrated in the OSA intermediate node (OSA gateway). An OSA intermediate node such as this may also provide other Application Programming Interfaces (APIs).

Thus, in summary, the network interface 2 uses the unit FW (framework) to offer the functions of authentication, authorization and grant of access, and carries out these functions. The network interface uses the access unit MNP-API to create the actual databank access to the MNP databank 1, in the process, the data processing device 4 asks a question (which, for example, includes the mobile radio call number of the communication terminal) of the MNP databank 1, and the MNP databank 1 provides information about stored MNP data relating, for example, to a network operator, gateway MSC or payment systems.

In this case, the method may be carried out in such a way that, once a single read authorization check has been carried out by the unit FW, a number of accesses may be made to the MNP memory. This may relate, for example, to the read requests which are transmitted within a context or via a tie line 9 from the data processing device 4 to the access unit MNP-API.

The connection between the MNP databank 1 and the network interface 2 may, for example, be provided using the “Lightweight Directory Access Protocol Version 3” (LDAPv3).

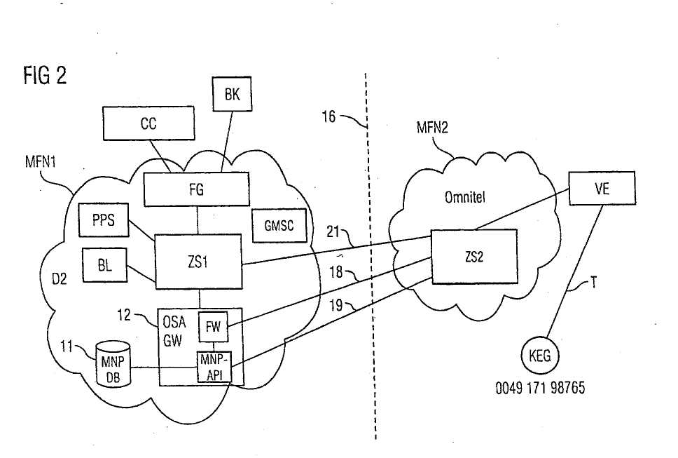

A first mobile radio network MFN1 is shown on the left-hand side of FIG. 2, and a second mobile radio network MFN2 is shown on the right-hand side. The first mobile radio network MFN1 may, for example, be the mobile radio network of the D2 Vodafone company in Germany. The second mobile radio network MFN2 may, for example, be the Italian mobile radio network Omnitel. A communication terminal KEG of a mobile radio subscriber who signed a mobile radio contract with the D2 Vodafone Company is shown on the right-hand side of FIG. 2. In consequence, the first mobile radio network MFN1 is the home mobile radio network for the communication terminal KEG.

The mobile radio call number allocated as the MSISDN to the communication device KEG is “0049 171 98765”. To be precise, the mobile call number MSISDN is not allocated to the communication terminal KEG, but is generally stored on a smart data card (SIM card). This SIM card can be inserted into the respective mobile telephone to be used by a mobile radio subscriber, after which that mobile telephone can be called at this mobile telephone number. However, since the SIM card is only inserted in one mobile radio telephone when making a mobile radio call, and must be connected to it, it can be said that the mobile radio call number MSISDN is allocated to this communication terminal KEG for this communication connection. The wording as mentioned above should be understood in this context.

The first mobile radio network MFN1 has a first associated payment system ZS1, via which payments made with regard to the communication terminal KEG (and which may occur, for example, when using the communication terminal KEG for buying and selling purposes in what is referred to as mobile commerce) are handled. For this purpose, the first payment system ZS1 is connected to an invoice production device BL and to a prepaid debiting device PPS. The first payment system ZS1 is also connected via a financial interface FG, which is referred to as “Financial Gateway”, to a debiting system CC for a credit card organization, and to a debiting system BK for a bank.

The first payment system ZS1 is likewise connected to a network interface 12, which is designed in the same way as the network interface 2 explained in conjunction with FIG. 1. The network interface 12 accordingly likewise has a unit FW and an access unit MNP-API. The latter is connected to an MNP memory 11, which is designed in the same way as the MNP memory 1 explained in conjunction with FIG. 1.

The second mobile radio network MFN2, which is shown on the right-hand side of FIG. 2, has a second payment system ZS2, which is used for initiating and implementing payments that are incurred in conjunction with the use of the second mobile radio network MFN2. The second payment system ZS2 is connected to a sales device VE, at least at times. A sales device VE such as this is represented, by way of example, by a computer via which a provider of goods or services offers his goods or services to customers who are interested in them, and/or also handles the sales and debiting procedures.

Both the first payment system ZS1 and the second payment system ZS2 are in each case operated by what is referred to as a payment service provider. The task of the payment service provider is to use the respective payment system to handle payments between those making payments and those receiving payments. A person making a payment may, for example, be a customer who is purchasing goods or services; a person receiving a payment may, for example, be a dealer who is offering goods or services.

The separation between the first mobile radio network MFN1 and the second mobile radio network MFN2 is symbolized by a vertical dashed line 16. This line 16 corresponds to the horizontal dashed line 6 shown in FIG. 1.

One exemplary embodiment of the invention will be described in the following text in the context of a sales procedure.

The user of the communications terminal KEG makes a mobile telephone call T to the sales device VE of an Italian dealer, and purchases an item via this mobile telephone connection T. The call number 0049 171 98765 of the communication terminal is transmitted via the mobile telephone connection T to the dealer's sales device VE; the dealer uses this mobile radio call number to debit the purchase price of the item bought.

The operator of the sales device VE is a mobile radio customer in the second mobile radio network MFN2. The second mobile radio network MFN2 in consequence represents the home network of the sales device operator. In consequence, the sales device VE uses the second payment system ZS2 for the second mobile radio network MSN2 as standard for handling payment procedures. An appropriate contract may exist between the operator of the second mobile radio network MFN2 and the sales device VE.

As has already been explained above, the operator of the communication terminal KEG is registered in the first mobile radio network MFN1. The first mobile radio network MFN1 thus represents the home network of the operator of the communication terminal, and thus also represents the home network of the communication terminal. In consequence, the purchasing procedures which are initiated or carried out using the communication terminal KEG are debited as standard using the first payment system ZS1 for the first mobile radio network MFN1.

For this reason, in order to handle this international purchasing procedure for the second payment system ZS2, it is necessary to identify the payment system which is associated with the communication terminal KEG and will handle these payments (that is to say the payment system ZS1). In this context, identification for the communication terminal (in this case the mobile radio call number which was transmitted by the sales device KE to the second payment system ZS2) is known by the second payment system ZS2. The national dialing code (“0049”) in the mobile radio call number tells the second payment system that the home network of the communication terminal KEG is in Germany. However, the second payment system cannot directly determine the home network of the communication terminal from the network code (“171”) in the mobile radio call number. This is because the second payment system ZS2 does not know whether the subscriber with the communication terminal KEG has already changed his mobile radio provider on one or even more occasions, and has retained his originally allocated mobile radio call number on the basis of mobile number portability.

This is because it is possible for different mobile radio providers to make use of a number of payment systems as well in a country where there are a number of mobile radio networks (for example one payment system for the first mobile radio network MFN1, and a further payment system for a further mobile radio network, which is not shown). Thus, in the illustrated example, the second payment system ZS2 cannot use the mobile radio call number to unambiguously decide whether the first payment system ZS1 for the first mobile radio system or the further payment system (which is not illustrated) for the further mobile radio network (which is not illustrated) is responsible for the purchasing procedure carried out by means of the communication terminal KEG. For this reason, the second payment system ZS2 now accesses the MNP memory 11.

The rest of the procedure corresponds to the procedure already described in conjunction with FIG. 1. First, the second payment system ZS2 uses an information channel 18 to set up a connection to the network interface 12. The second payment system ZS2 authenticates itself with the framework FW of the OSA gateway 12 via this connection 18. After this, the OSA gateway authorizes this second payment system ZS2 to use the access unit MNP-API. Once this authorization has been obtained, the second payment system ZS2 can access the MNP memory 11 via the access unit MNP-API, and can make appropriate access requests to the MNP databank 11. When an access request such as this occurs, the second payment system ZS2 transmits the mobile radio call number MSISDN of the mobile telephone of the subscriber wishing to make a purchase via a data channel 19 to the network interface 12. The network interface 12 then asks the MNP memory 11 for the network operator (in this case the operator D2) associated with the communication terminal KEG, and for the server address of the responsible first payment system ZS1. The information about the network operator and about the server address is transmitted with the aid of the access unit MNP-API in a response message from the network interface 12 via the data channel 19 to the second payment system ZS2.

The second payment system ZS2 now has the necessary information to make contact with the first payment system ZS1. Using the server address for this first payment system ZS1, it sets up a data link 21 to the first payment system ZS1 (“Inter-Payment Service Provider Routing”). Payments can now be handled correctly between the second payment system ZS2 and the first payment system ZS1 (“Inter-Payment Service Provider Payment”).

So far, it has been assumed in this exemplary embodiment that the subscriber with the communication terminal KEG has not changed his original mobile radio network. In consequence, the first mobile radio network MFN1 was entered in the MNP memory 11 as the home network, and the first payment system ZS1 was entered in the MNP memory 11 as the responsible payment system. However, if the corresponding subscriber had already changed the mobile radio network (for example to the further mobile radio network which has already been mentioned above but is not shown), then the further mobile radio network would be entered in the MNP memory 11 as the home mobile radio network, and the further payment system for the further mobile radio network would be entered in the MNP memory 11 as the responsible payment system. Consequently, the server address for this further payment system would then have been transmitted to the second payment system ZS2, in response to which the second payment system would have set up a data link to the further payment system, in order to handle the payment.

The invention can also advantageously be used when a land line subscriber is calling a ported mobile radio subscriber (that is to say a mobile radio subscriber who has churned, taking his original mobile radio number with him). In order to set up cost-effective rerouting directly from the land line network to the currently responsible network for the mobile radio subscriber for a telephone call such as this, the land line network operator likewise requires MNP data stored in the MNP memory 11. This data can also be checked from the MNP memory analogously to the exemplary embodiment described above using the network interface with the framework unit FW and the access unit MNP-API by a data checking device in the land line network (which represents a network-external data processing device with regard to the mobile radio network).

A method and an arrangement have been described which allow secure access from devices external to mobile radio networks to number porting data which is stored in “Mobile Number Portability” databanks. This method and this arrangement can be cost-effectively embedded in existing network infrastructures since, according to the invention, an access unit for access to MNP data is provided by means of the OSA technology, which is known per se. This method allows, for example, cost-effective rerouting from land line networks to mobile radio networks when called mobile radio subscribers have ported. International processing and payment procedures supported by mobile radio are likewise made possible for ported mobile radio subscribers using their payment systems.

It is particularly advantageous for the access unit MNP-API to be designed to be compliant with the OSA Standard. This makes it possible, according to the invention, to use security mechanisms and security infrastructures which are known from the OSA Standard—for example in the framework unit—for access to the MNP data; this allows smooth interaction, for example, between the access unit and the framework unit.

What is claimed is:

1. A method for accessing MNP data, which is stored in an MNP memory in a mobile radio network, by a network-external data processing device, comprising:
arranging a network interface, in terms of signal flow, between the network-external data processing device and the MNP memory, and which checking whether the network-external data processing device is authorized to access the MNP data;
if the authorization is present, transmitting an identification for a communication terminal by the network interface from the network-external data processing device to the MNP memory;
reading MNP data which is associated with the communication terminal from the MNP memory; and
transmitting the MNP data via the network interface to the network-external data processing device.

2. The method as claimed in claim 1, wherein the network interface carries out an authentication and authorization of the data processing device to check the authorization of the data processing device.

3. The method as claimed in claim 1, wherein the authentication and authorization are carried out by a network interface, which is in the form of an OSA intermediate node, in accordance with OSA requirements.

4. The method as claimed claim 1, wherein the MNP data is transmitted via a network interface which has an access unit in the form of an OSA-conformal application programming interface.

5. The method as claimed in claim 1, wherein an identifier for the home mobile radio network of the communication terminal is transmitted as the MNP data.

6. The method as claimed in claim 1, wherein an address of an entry switching center for the mobile radio network of the communication terminal is transmitted as the MNP data.

7. The method as claimed in claim 1, wherein access data for a payment system, which is associated with the communication terminal, for the mobile radio network of the communication terminal is transmitted as the MNP data.

8. The method as claimed in claim 7, wherein a data processing device, which operates as a payment system and is associated with some other mobile radio network, transmits an access request, relating to the MNP memory, to the network interface,
if an authorization for the data processing device is present, a mobile radio call number is transmitted to the MNP memory as an identification for the communication terminal,
the access data for the payment system, which is associated with the communication terminal, for the mobile radio network of the communication terminal is then read from the MNP memory as MNP data, and
the access data is transmitted to the data processing device.

9. An arrangement, comprising:
an MNP memory for a mobile radio network, which includes MNP data in the form of association data between identifications for communication terminals and devices in the mobile radio networks of the communication terminals; and
a network interface for the mobile radio network, which allows a network-external data processing device to have access to the MNP data.

10. The arrangement as claimed in claim 9, wherein the network interface is in the form of an intermediate node which operates in accordance with OSA requirements.

11. The arrangement as claimed in claim 9, wherein a subscriber payment system for the mobile radio network, whose access data is stored as MNP data in the MNP memory.
